(19) United States
(12) Patent Application Publication
(10) Pub. No.: US 2017/0224451 A1
(43) Pub. Date: Aug. 10, 2017

(54) METHOD OF MAKING A DENTAL PROSTHESIS

(71) Applicant: BREDENT GmbH & Co. KG, Senden (DE)

(72) Inventors: Peter BREHM, Senden (DE); Heiner Weber, Tuebingen (DE)

(21) Appl. No.: 15/018,236

(22) Filed: Feb. 8, 2016

(51) Int. Cl. A61C 13/34; A61C 13/10; A61C 13/20; A61C 9/00; A61C 8/00; A61C 13/00

(52) U.S. Cl. CPC A61C 13/34; A61C 8/0001; A61C 13/0028; A61C 13/206; A61C 8/0069; A61C 9/00; A61C 13/1003; A61C 13/0003

(57) ABSTRACT

The method is used for making a dental prosthesis or for the adaptation of an existing dental prosthesis for the inclusion in and attachment to existing residual dentition and/or at least one implant. Here, individual teeth and/or implants and/or the remains thereof form the anchor elements for anchoring the dental prosthesis. First, an imprint of the actual condition of the jaw of the patient occurs, from which a master model and a working model are molded. Then, the working model is adjustably fixed in a milling base and aligned with respect to the insertion direction in a milling machine or parallelometer. Next, adhesion surfaces (2) made from wax in the manner of wide-area brackets, an adhesive bridge or the like are molded onto the molded anchor elements (1). Then a molded connecting part (3) with a permanently attached parallelization pin (4) and/or retention anchor element is waxed thereon after successful alignment with the insertion direction by means of the parallelization pins (4). Subsequently either the teeth (7) forming the dental prosthesis, the cast-model framework (8) and further necessary parts are modeled in wax, or the already an existing dental prosthesis are modeled on. Finally the model is provided with injection molding passages (9), and for this purpose each of the elements is worked on individually. Then, the model is embedded and boiled out for removing the wax, and that finally after insertion of the interchangeable matrix (duplicating matrix) into the molded connecting part (3) and surface treatment of the mold inner surfaces and the plaster mold, the mold is removed, followed by the removal of the dental prosthesis.

### CROSS REFERENCE TO RELATED APPLICATIONS

This application claims the priority of German patent application 10 2014 019 519.8 filed 24 Dec. 2014.

### FIELD OF THE INVENTION

The invention relates to a method of making a dental prosthesis or for the adaptation of an existing dental prosthesis for the inclusion in and attachment to existing residual dentition and/or at least one implant, where individual teeth and/or implants and/or the remains thereof form anchor elements for the dental prosthesis.

### BACKGROUND OF THE INVENTION

Both from practice as well as from the literature, numerous and very different methods of this type are known that make it possible in very different manners to replace missing teeth in the mouth of a patient. Some of these methods are very time-consuming and costly, with the result that they at times fall out of consideration for individual patients on the basis of financial or time reasons.

### OBJECT OF THE INVENTION

The object of the present invention is to provide a method of the above-described type in which the preparation of a dental prosthesis or adaptation of an existing dental prosthesis, such as in the loss of a tooth that was previously used as a anchor element, can be achieved not only with a minimal expenditure of time for the patient, but also such that the dental prosthesis created in this way is cost efficient and makes the greatest possible further use of an existing dental prosthesis.

### SUMMARY OF THE INVENTION

The method according to the invention is characterized in that first an imprint of the actual condition of the jaw of the patient is made and from this a master model and a working model are molded, that then the working model is adjustably fixed in a milling base and aligned with respect to the insertion direction in a milling machine or parallelometer, that next adhesion surfaces made from wax in the manner of wide-area brackets, an adhesive bridge or the like are molded onto the molded anchor elements, that then a molded connecting part with a permanently attached parallelization pin and/or retention anchor element is waxed thereon after successful alignment with the insertion direction by means of the parallelization pins, that subsequently either the teeth forming the dental prosthesis, the cast-model framework and further necessary parts are modeled in wax, or the already an existing dental prosthesis are modeled on, and that finally the model is provided with injection molding passages, and for this purpose each of the elements is worked on individually, that then the model is embedded and boiled out for removing the wax, and that finally after insertion of the interchangeable matrix (duplicating matrix) into the molded connecting part and surface treatment of the mold inner surfaces and the plaster mold, the mold is removed, followed by the removal of the dental prosthesis.

The advantage achieved by the invention is first that the patient requires only one session at the dentist to make an impression of the residual dentition of his or her jaw, and only one further session for the insertion of the completed work. Above all, as a rule, there is no need for preparatory work on the remaining teeth of the residual dentition. A further advantage is the simplified production of the dental prosthesis in the laboratory, as the injection of the primary and secondary parts, i.e. the cast-model framework including the teeth to be replaced, takes place in a single process. In addition to time savings, this also results in significant cost reduction. In particular, however, in the case of a fallen off or lost holding tooth or anchor element, preexisting dental prosthesis, which may consist of plastic or metal or possibly other materials, can be readily re-anchored in the same time and cost-effective manner to another anchor element. Here, there is the further possibility of freely selecting the design of the molded connecting part. It may thus be formed as a permanent mold, as a cone or parallel sleeve or as an attachment part, and the possibility also exists in the design to provide a latching of the male attachment part through the so-called “snap effect.” It is also provided within the context of the invention that the primary part (crown with male attachment/anchor element with male attachment) and the secondary part (cast-model and possible teeth to be expanded) are prepared with a CAD-CAM method, and for the secondary part, space for the bonding surface to the attachment housing and the bonding gap of the attachment housing necessary for adhesion (passive bonding, no tension) must be planned for, in which subsequently the attachment housing is adhered after exact positioning on the male attachment (primary part).

In an advantageous development of the invention, the individual injection passages may be grouped into one or more injection openings, whereby in the latter case the possibility exists to inject different plastics with different properties into the individual injection passages.

The possibility further exists to insert a special matrix (duplicating matrix) into the molded connecting part formed as a molded component before the injection process, in order to allow this to be replaced before completion and insertion in the patient and replaced by a special matrix (friction matrix).

After the described inventive procedure, it is usually only necessary after removal to clear the partition plate and lower face of possible over-injected material and separate the casting passages.

Here, it may also be necessary or advantageous within the context of the invention that the removed and cleared dental prosthesis be finished for final adjustment to the master model.

Additionally, it has proven advantageous within the context of the invention if after the production of the working model in the milling machine or parallelometer, the piece to be finished is first aligned to the working model, then applied with a plaster sealant below the prosthetic equator, i.e. areas of overhang, and finally applied with a modeling resin to the sealed locations for filling these areas of overhang.

Further, it is advantageous if the molded connecting part is freely basally adjusted to the model orientation before insertion.

Another advantageous approach in the process is characterized in that when modeling the teeth, the occlusal surfaces thereof are formed by separately finished and placed wax occlusal surfaces or, instead, teeth made from wax or prefabricated plastic teeth are used.

It has also proven to be advantageous if, before the embedding of the model, a partition plate of the molded connecting part is slightly exposed with a modeling instrument for additional exact fixing.

To further enable later easy removal from the mold, it is further advantageous to coat a surface of the mold inner surfaces with a release agent such as an ‘amtstartexactoform coating.

Finally, it is expedient for the same reasons if the plaster molds are internally coated with a release agent.

According to a further alternative embodiment of the invention, in molded connecting parts made from metal or consisting of another material, an embedding of the piece to be injected in a muffle suitable for the pressing of thermoplastics may take place, and in the use of the cast-model technique, a working model is first created from embedding material, and a necessary special matrix (duplicating matrix) is inserted into the attachment housing, while in the use of the lift-off technique, the master model is worked directly and here a necessary special matrix (duplicating matrix) is inserted in the attachment housing before the embedding of the model in the muffle, that then the model is provided with injection molding passages, to which end each of the elements is worked on individually, and the model is then embedded in a muffle mold with embedding material, then a preheating oven is fired and, after cooling to the necessary injection temperature, injected in a pressing furnace, or after cooling to room temperature embedded in a cuvette and sprayed with a thermoplastic, whereupon the removal takes place as described above.

The object of the invention is further a molded connecting part for performing the method described, consisting of a molded part as well as one or more parallelization pin(s) and/or retention anchor element(s) that is/are firmly attached via a spacer to the molded part, and the parallelization pin is aligned parallel to the insertion direction of the dental prosthetic predetermined by the molded part.

In an advantageous embodiment here, the molded part may be formed by a framework provided to remain in the dental prosthesis.

The possibility also exists, however, that the molded part is formed as a male attachment part.

Finally, the molded part may also be formed as a cone or parallel sleeve, or in the form of a double sleeve for placement on a tooth stump or abutment.

### BRIEF DESCRIPTION OF THE DRAWING

Hereinafter, the method will be explained in more detail with reference to an embodiment shown in the drawings.

FIGS. 1A and 1B show a dental prosthesis produced according to the method placed on the master model for finishing,

FIG. 2 shows the dental prosthesis according to FIG. 1 without the base model, but divided into primary and secondary parts at the molded connecting parts,

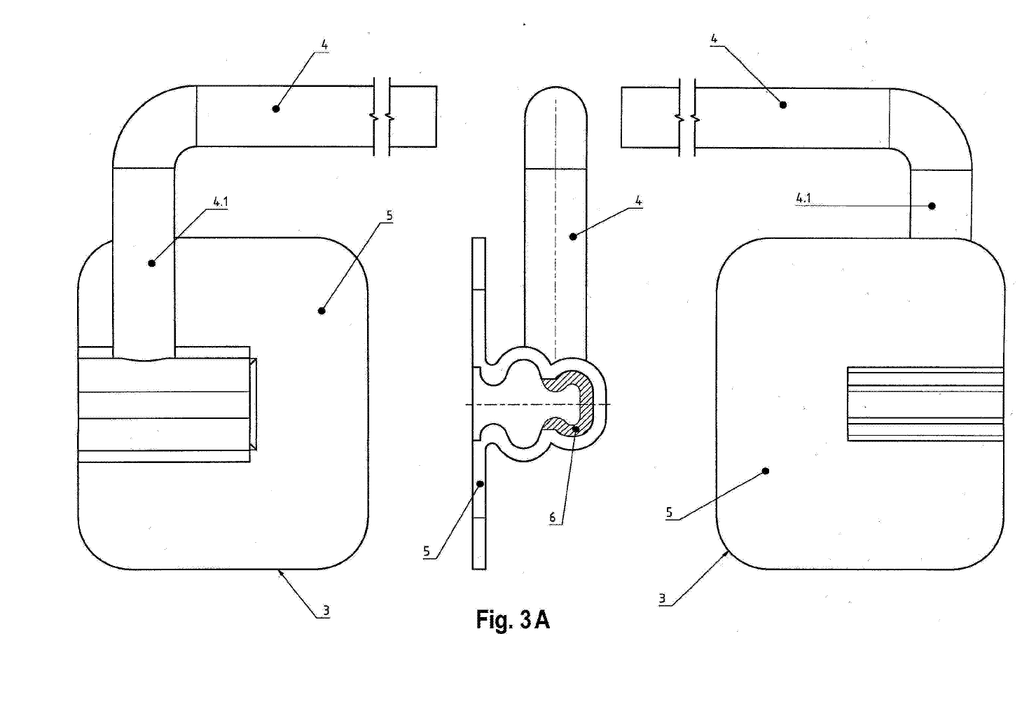

FIGS. 3A and 3B show a single molded connecting part in two different configurations, and

FIGS. 4A and 4B show a further molded connecting part, also in two different configurations.

### SPECIFIC DESCRIPTION OF THE INVENTION

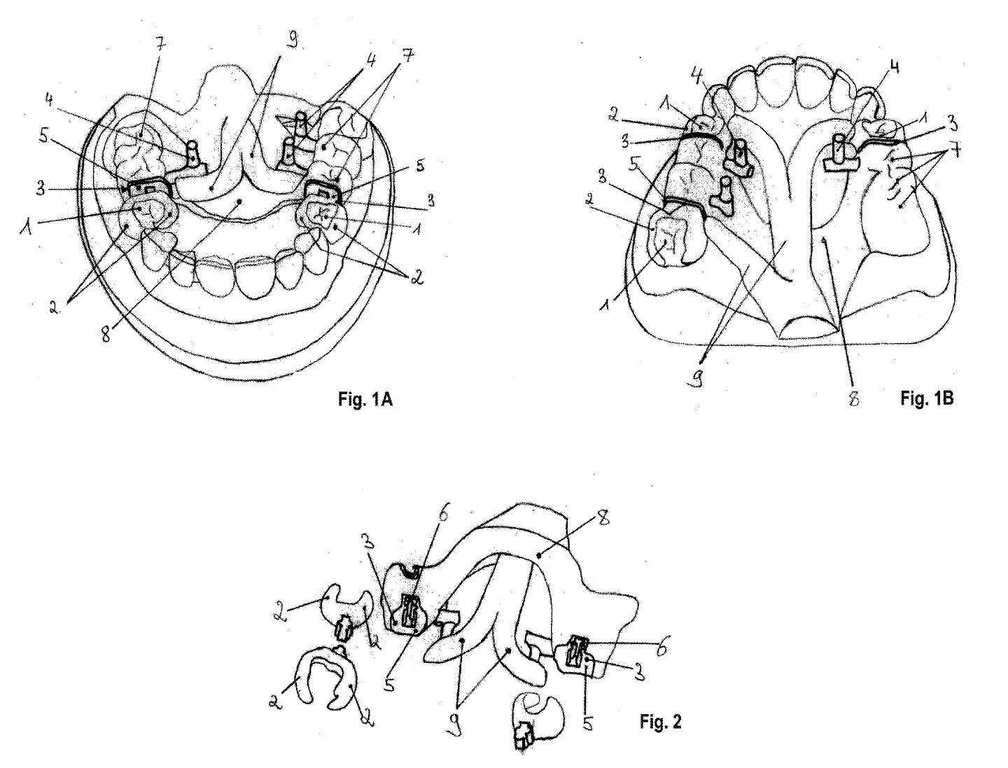

The dental prosthesis shown in the drawing is intended for inclusion in and attachment to existing residual dentition and/or at least one implant. Here, the individual teeth or implants form anchor elements for the dental prosthesis, as can be seen from FIGS. 1A and 1B.

For the preparation of this dental prosthesis, an imprint of the actual condition of the patient's jaw is first undertaken, and from this a master model and a working model are molded that then have the form shown by way of example in FIGS. 1A and 1B. In a manner not shown in detail in the drawing, the working model is adjustably fixed in a milling base and aligned with respect to the insertion direction in a milling machine or parallelometer.

Then, adhesion surfaces 2 made from wax in the manner of wide-area brackets are molded onto the anchor elements 1, i.e. the formed anchoring elements for the dental prosthesis in the mouth of the patient (teeth, implants or the residue thereof). Depending on the actual condition of the jaw, however, adhesive bridges or similar forms can also be molded on. Then, a molded connecting part 3 with a permanently attached parallelization pin 4 is waxed thereon, and thereafter an alignment to the insertion direction of the dental prosthesis takes place by means of the parallelization pin 4.

Subsequently, the teeth 7 forming the dental prosthesis, the cast-model framework 8 and further necessary parts are modeled in wax and the model is then provided with injection-molding passages 9. Here, each of the elements is worked on individually with the injection molding passages 9, as is likewise shown by way of example in FIGS. 1A and 1B.

Then the model is embedded in a known manner and then boiled out or burnt out to remove the wax. Finally, after insertion of the matrices forming the friction part 6 into the molded connection part 3 and a surface treatment of the mold inner surfaces and the plaster mold, the filling of the mold takes place, followed by removal of the dental prosthesis.

Here, the individual injection molding passages 9 can be grouped into one or—in a manner not shown in detail in the drawing—also into multiple injection openings, and then the possibility exists to inject different plastics into individual regions.

After removal, the dental prosthesis substantially has the appearance shown in the drawing, so that for the molded connecting part 3 formed as a housing mold part, first the partition plate 5 and the lower face is cleared of possible over-injected material and the injection molding passages 9 present are separated.

Finally, the removed and cleared dental prosthesis can be finished for final adjustment to match the master model.

For optimal processing, the method according to the invention provides further intermediate steps; in particular, after the production of the working model in the milling machine or parallelometer, the piece to be finished is first usually aligned to the working model, subsequently coated with a plaster sealant below the prosthetic equator, i.e. areas of overhang or undercut, and finally applied with a modeling resin to the sealed locations for filling these areas of overhang.

Further, it is advantageous here if the molded connecting part is freely basally adjusted to the model orientation before insertion.

In principle, with regard to the health of the patient, sufficient possibility for periodontal hygiene must also be considered.

To simplify modeling of the teeth 7, it is recommended to form the occlusal surfaces thereof through separately finished and applied wax occlusal surfaces. Likewise, however, teeth made from wax or prefabricated plastic teeth can be used instead.

It has also proven to be useful if, before the embedding of the model, the partition plate 5 of the molded connecting part 3 is slightly exposed with a modeling instrument for additional exact fixing.

Finally, it is advantageous in a known manner for easy removal of the cast dental prosthesis from the mold to provide a surface treatment of the mold inner surfaces with a release agent such as an exactoform coating. Similarly, the plaster molds should be painted with the release agent.

In a further variant not shown in the drawings, in which a molded connecting part 3 made from metal or consisting of another material is used, an embedding of the piece to be injected in a muffle suitable for the pressing of thermoplastics takes place, and in the use of the cast-model technique, a working model is first created from embedding material that is reduced in size with respect to the muffle before the modeling. Here, the placeholder for the special matrix (duplicating matrix) is used before modeling. In the use of the lift-off technique, however, the master model is worked directly and here the placeholder for the special matrix (duplicating matrix) is inserted before the embedding of the model in the muffle. Then the model is provided with injection molding passages 9, to which end each of the elements is worked on individually, and the model is then embedded in a muffle mold with embedding material and subsequently fired in a preheating oven. After cooling to the necessary injection temperature, injection molding can be done in a pressing furnace or after cooling to room temperature embedded in a cuvette and sprayed with a thermoplastic. Thereafter, removal takes place in the manner described above.

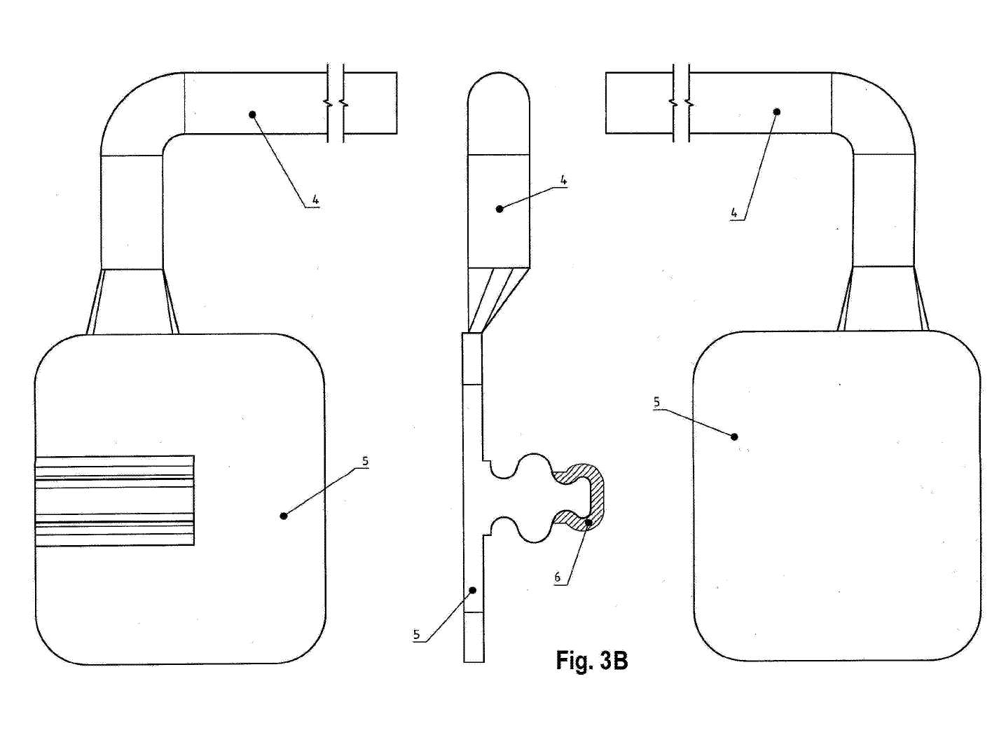

In FIGS. 3A and 3B, a molded connecting part is shown by way of example, as it can be used for carrying out the method according to the invention. It consists of a molded part and a parallelization pin that is firmly connected via a spacer 4.1 to the molded part. Here, the parallelization pin is aligned parallel to the insertion direction of the dental prosthetic predetermined by the molded part.

In this embodiment, the molded part may be formed by a framework provided to remain in the dental prosthesis. In partial FIG. 3A, the molded connecting part is provided with a housing, while in partial FIG. 3B a male part is provided, so that the molded part is formed as an attachment part.

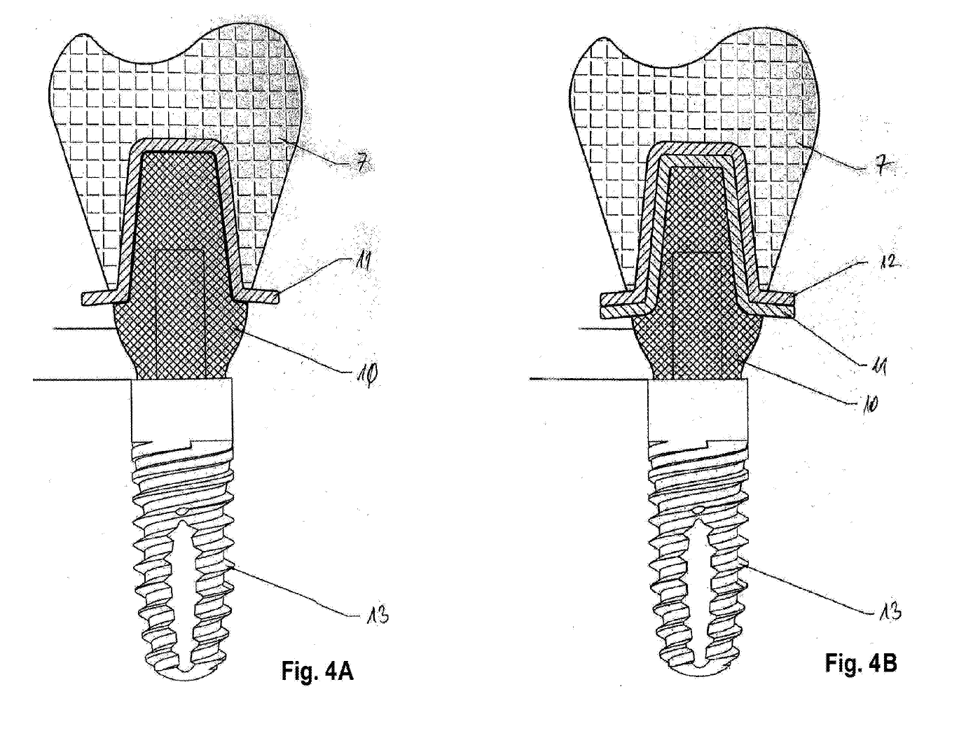

In the manner shown in FIGS. 4A and 4B, the molded part may also finally be formed as a cone or parallel sleeve 11 for placement on a tooth stump or an abutment 10 on an implant 13, where—as can be seen in partial FIG. 4B—a design in the form of a double crown 11, 12 is also possible.

1. A method of making a dental prosthesis or for the adaptation of an existing dental prosthesis for the inclusion in and attachment to existing residual dentition and/or at least one implant where individual teeth and/or implants and/or the remains thereof form the anchor elements for anchoring the dental prosthesis, the method comprising the steps of:
first making an imprint of the actual condition of the jaw of the patient occurs and then molding from the imprint a master model and a working model are molded;
adjustably fixing the working model in a milling base and aligning the working with respect to the insertion direction in a milling machine or parallelometer;
molding adhesion surfaces made from wax in the manner of wide-area brackets, an adhesive bridge or the like onto the molded anchor elements;
waxing on a molded connecting part with a permanently attached parallelization pin and/or retention anchor element after successful alignment with the insertion direction by means of the parallelization pins;
modeling either the teeth forming the dental prosthesis, the cast-model framework and further necessary parts in wax, or modeling on the already existing dental prosthesis;
providing the model with injection molding passages, and for this purpose working each of the elements individually;
embedding the model and boiling out the wax;
inserting an interchangeable matrix into the molded connecting part and surface treating the mold inner surfaces and the plaster mold, removing the mold and then removing of the dental prosthesis.

2. The method according to claim 1, wherein the individual injection molding passages are connected to one or more injection openings.

3. The method according to claim 1, further comprising the step of:
inserting a special matrix into the molded connecting part formed as a molded housing part before the injection process in order to allow it to be replaced before completion and insertion in the patient and replaced by a special matrix.

4. The method according to claim 1, further comprising the step, after removal, of:
forming a partition plate on the molded connecting part a molded housing part and clearing a lower face of possible over-injected material and removing the molding passages.

5. The method according to claim 1, further comprising the step of:
finishing the removed and cleared dental prosthesis for final adjustment to the master model.

6. The method according to claim 1, further comprising the steps of,
after the production of the working model in the milling machine or parallelometer aligning the piece to be finished to the working model, then
applying a plaster sealant below the prosthetic equator to areas of overhang, and finally
applying a modeling resin to the sealed locations for filling these areas of overhang.

7. The method according to claim 1, further comprising the step of:
orienting the molded connecting part to the model orientation before insertion.

8. The method according to claim 1, further comprising the step, when modeling the teeth, of:
separately wax finishing the occlusal surfaces thereof and thereafter
placing the waxed occlusal surfaces or teeth made from wax or prefabricated plastic teeth.

9. The method according to claim 1, further comprising, before the embedding of the model, the step of:
slightly exposing a partition plate of the molded connecting part with a modeling instrument for additional exact fixing.

10. The method according to claim 1, wherein the surface treatment of the mold inner surfaces is carried out with a release agent.

11. The method according to claim 10, wherein the plaster molds are painted with the release agent.

12. The method according to claim 1, further comprising the steps, in molded connecting parts made from metal or consisting of another material, of:
embedding of the piece to be injected in a muffle suitable for pressing of thermoplastics, and, in the use of the cast-model technique,
first creating a working model from embedding material, and inserting a necessary special matrix into an attachment housing, while, in the use of the lift-off technique,
working directly on the master model and here inserting a special matrix in the attachment housing before embedding the model in the muffle, and then providing the model with injection molding passages, to which end each of the elements is worked on individually, and then embedding the model is in a muffle mold with embedding material, then firing the model embedded in the muffle mold in a preheating oven and, after cooling to the necessary injection temperature, injection filling the fired model in a pressing furnace, or after cooling to room temperature the fired mold in a cuvette and spraying the fired mold with a thermoplastic, whereupon the dental prosthesis is removed from the mold.

13. A molded connecting part for performing the method according to claim 1, consisting of a molded part as well as one or more parallelization pin and/or retention anchor element that is/are firmly attached via a spacer to the molded part, the parallelization pin or retention anchor element being aligned parallel to the insertion direction of the dental prosthetic predetermined by the molded part.

14. The molded connecting part according to claim 12, wherein the molded part is a framework provided to remain in the dental prosthesis.

15. The molded connecting part according to claim 12, wherein the molded part is a male attachment part.

16. The molded connecting part according to claim 12, wherein the molded part is a frustocone or parallel sleeve for placement on a tooth stump or an abutment.
